(19) United States
(12) Patent Application Publication
(10) Pub. No.: US 2009/0185963 A1
(43) Pub. Date: Jul. 23, 2009

(54) METHOD FOR MAKING DIESEL FUEL ADDITIVE

(76) Inventor: Arlis Hanson, Bath, SD (US)

Correspondence Address: SCHWEGMAN, LUNDBERG & WOESSNER, P.A., P.O. BOX 2938, MINNEAPOLIS, MN, 55402, US

(21) Appl. No.: 12/357,804

(22) Filed: Jan. 22, 2009

Related U.S. Application Data
(60) Provisional application No. 61/022,678, filed on Jan. 22, 2008.

(51) Int. Cl. B01J 19/00

(52) U.S. Cl. 422/198

(57) ABSTRACT

Embodiments described herein include a system for making a biofuel, comprising: one or more vessels for storing an unreacted oil or fat; an enclosed vessel and mixer for mixing ethanol and a catalyst in quantities effective to make a biofuel; a vessel for mixing the oil or fat with the ethanol and catalyst to make a blend; a pressurized vessel for subjecting the blend to a pressure of 7500 to 8000 psi; an expansion vessel for releasing pressure on the blend; and a vessel with heating elements for heating the blend.

### RELATED APPLICATIONS

This application claims the benefit under 35 U.S.C. 119(e) of U.S. Provisional Patent Application Ser. No. 61/022,678, filed on Jan. 22, 2008, which is incorporated herein by reference in it entirety.

### SUMMARY OF THE INVENTION

Embodiments described herein relate to system embodiments for making biofuels, and biofuel additives, and method embodiments for making biofuels and biofuel additives.

### BACKGROUND

Efforts to find alternative fuels to those derived from petroleum, such as gasoline and diesel fuel, have led to the development of biodiesel fuel. Traditional biodiesel is produced by transesterification of vegetable oils or fats. In such a process, a vegetable fat or oil reacts with an esterifying agent, typically methanol, with or without a catalyst and with the input of additional energy usually at atmospheric pressure. The time of the reaction can range from 0.5 to 8 hours, depending on the temperature.

### DESCRIPTION OF THE FIGURES

FIG. 1 illustrates a schematic view of one embodiment of the system for making biofuels and biofuel additives, of the invention.

### DETAILED DESCRIPTION

Although detailed embodiments of the invention are disclosed herein, it is to be understood that the disclosed embodiments are merely exemplary of the invention that may be embodied in various and alternative forms. Specific structural and functional details disclosed herein are not to be interpreted as limiting, but merely as a basis for teaching one skilled in the art to variously make food cluster embodiments.

As used herein, the terms “oils” and “fats” are chemically interchangeable, the distinction between such products being that they are merely distinguished on the basis of their physical state. To avoid confusion with other types of oils, such as essential oils or oils derived from petroleum, these products will be identified to the extent possible as “vegetable or animal oils” or “vegetable or animal fats” but unless the context clearly indicates otherwise, a reference to fats and oils should be understood to refer to vegetable or animal oil components as opposed to petroleum oils.

A common vegetable-oil-derived fuel, typically used as a fuel for diesel engines is referred to as “biodiesel”. Biodiesel has historically been made utilizing the chemical reaction known as transesterification. The process forms two principal products, fatty acid methyl esters, FAME, the chemical name for biodiesel, and glycerin. In this reaction, a vegetable oil or fat reacts with an esterifying agent, usually an alcohol, with or without a catalyst and with the input of additional energy, normally at atmospheric pressure. The reaction time can vary from about 0.5 to about 8 hours depending on the temperature and whether or not a catalyst is used. A biodiesel fuel generated in this way and used as a fuel and not as an additive with a petroleum based fuel or ethanol, at 100%, is referred to as “B 100”. If the biofuel is used as an additive with another fuel, such as diesel fuel or gas or oil, the biofuel is typically identified by the percentage of biodiesel present, such as, B5, B20, B30, and so forth.

The principal physical and chemical properties of conventional biodiesel are as follows: methyl ester content >96.5%; Density at 15 degrees C. ranges from about 0.86 to about 0.90 g/cc; viscosity at 40 degrees C. ranges between about 3.5 and about 5.0 mmVs; flammability point >110 degrees C.; Cetane number >51; net heating value equal to about 33175 kJ/L, compared to typical No. 2 diesel fuel, biodiesel has about 8.65% less heating value expressed as BTU/gal.; i.e., 118,296 versus 129,500).

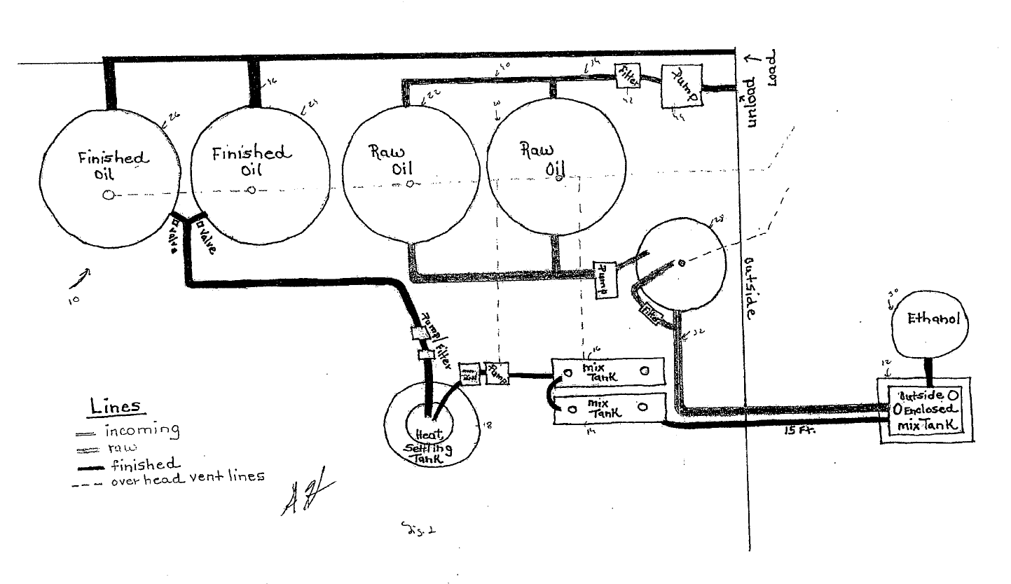

One system embodiment, for making a biofuel or a fuel additive, illustrated generally at 10 in FIG. 1, includes two or more storage vessels, shown as 20 and 22 for storing a raw, untreated reactant and vessels 24, 26 for storing a finished biofuel product. The raw, untreated reactanct includes fats and oils as described above. For one embodiment, the raw oil is soy oil. The raw oil is received by the vessels 20 and 22 through a receiving system 34. The receiving system 34 includes lines 40, filtration 42 and one or more pumps 44. The receiving system 34 transports the raw oil from a shipping vessel transported by highway, rail, water, or other conventional transportation mode. The system 10 also includes a loading system 46 that including piping for transporting finished biofuel or fuel additive from vessels 26 and 24 for transport and use.

The system 10 also includes a mixing vessel 12 for mixing ethanol from vessel 30. A catalyst is also added to the vessel 12 and the catalyst and ethanol are blended. The mixing vessel 12 includes a mixer which is not shown. The raw soy oil or other oil or fat is added to the ethanol-catalyst blend in vessel 12 from one of the vessels 20 and 22 through a transport component 32. The blend of ethanol-catalyst-raw soy oil, for one embodiment, is mixed for about 20 minutes in the mix tank 12. Mixing continues while the blend is added to a high pressure vessel 14. The blend, made from the oil or fat, ethanol and catalyst is then transferred to a high pressure vessel 16. The pressure vessels 14 and 16 are at 7500 to 8000 psi. After subjecting the blend to high pressure, the blend is transported to an expansion vessel 18 where the blend is heated and particulates are settled. From the expansion/settling vessel 18, the product blend is added to the storage tanks 24 and 26. The product is filtered upon receipt, and also when the blend is mixed and prior to being sent to storage.

In one embodiment, 72 gallons of ethanol and 32 ounces of catalyst were added to 800 gallons of oil to make 872.5 gallons of biofuel. In a first step, ethanol was added to the mixing vessel 12. A catalyst is added to the mixing vessel 12 and the ethanol and catalyst were mixed. The raw oil may be soy oil or other type of vegetable oil. The raw oil was blended with ethanol and catalyst so that the ethanol was present in a quantity of 7 to 10% of the total product of raw oil and ethanol. The blend was mixed in the mix vessel 12 until bonding and was then transported to a high pressure vessel 14, with mixing. The bonded blend was subjected to a pressure within a range of 7500-8000 psi. The pressurized blend was then passed through the expansion vessel 18 and then to a heat and settling vessel. The finished product was filtered at least once and for some embodiments, several times before being sent to storage.

Since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes, which come within the meaning and range of equivalency of the claims, are intended to be embraced therein.

1. A system for making a biofuel, comprising:
One or more vessels for storing an unreacted oil or fat;
An enclosed vessel and mixer for mixing ethanol and a catalyst in quantities effective to make a biofuel;
A vessel for mixing the oil or fat with the ethanol and catalyst to make a blend;
A pressurized vessel for subjecting the blend to a pressure of 7500 to 8000 psi;
An expansion vessel for releasing pressure on the blend; and
A vessel with heating elements for heating the blend.
